(19) United States
(12) Patent Application Publication
(10) Pub. No.: US 2026/0046821 A1
(43) Pub. Date: Feb. 12, 2026

(54) SYSTEMS AND METHODS FOR UNMANNED AERIAL VEHICLE COMMUNICATION IN RESTRICTED AREAS

(71) Applicant: Telefonaktiebolaget LM Ericsson (PUBL), Stockholm (SE)

(72) Inventors: Muhammad Ali KAZMI, SUNDBYBERG (SE); Mattias BERGSTRÖM, SOLLENTUNA (SE); Hieu DO, JÄRFÄLLA (SE); Helka-Liina Määttänen, ESPOO (FI); Sathya Narayana VENKATASUBRAMANIAN, UPPLANDS VÄSBY (SE)

(21) Appl. No.: 19/102,340

(22) PCT Filed: Aug. 9, 2023
(86) PCT No.: PCT/EP2023/072088

§ 371 Date: Feb. 7, 2025

Related U.S. Application Data
(60) Provisional application No. 63/396,404, filed on Aug. 9, 2022.

(51) Int. Cl. H04W 64/00; H04B 17/318; H04W 16/28; H04W 36/08; H04W 52/36

(52) U.S. Cl. CPC H04W 64/00; H04B 17/318; H04W 16/28; H04W 36/08; H04W 52/367

(57) ABSTRACT

A method (700) by a user equipment, UE, (112) for communicating in a restricted zone includes determining (702) a location of the UE in relation to the restricted zone. Based on the location of the UE in relation to the restricted zone, the UE takes (704) at least one action to maintain a level of communication quality of the UE.

### TECHNICAL FIELD

The present disclosure relates, in general, to wireless communications and, more particularly, systems and methods for unmanned aerial vehicle communication in restricted areas.

### BACKGROUND

The world is witnessing a widespread and increasing use of Unmanned (or Uncrewed) Aerial Vehicles (UAV) such as, for example, drones, in many segments of the economy and in our daily life. There are numerous use cases of UAVs in industry, goods transportation and delivery, surveillance, media production, etc.

Traditionally, UAVs can only be flown by a controller within the visual line of sight (VLoS). Realizing the great potential of connecting drones beyond visual line of sight (BVLoS) via cellular network, 3^{rd} Generation Partnership Project (3GPP) have specified multiple features in Long Term Evolution (LTE) Release 15 (Rel-15), aiming at improving the efficiency and robustness of terrestrial LTE network for providing aerial connectivity services, particularly for low altitude UAVs. These features target both command-and-control traffic for flying the drone and the data (also known as payload) traffic from the drone to the cellular network. The key features specified include:
support for subscription-based identification;
height reporting when UAV crosses height threshold, including height, location (3D), horizontal and vertical speed;
Reference Signal Received Power (RSRP) reporting per event of N cells' signal power above a threshold, including RSRP/Reference Signal Received Quality (RSRQ)/location (3D);
User Equipment (UE)-specific uplink (UL) power control; and
flight path information provided from UE to eNodeB (eNB), including network polling and list of waypoints (3D location), time stamp if available.

These features were introduced targeting special needs when serving the UAVs by LTE network such as, for example, the need for flying mode detection, interference detection, and interference mitigation.

In Release 18 (Rel-18), 3GPP is working on including these same LTE features in the New Radio (NR) interface. Some features related to broadcasting the UAV identity and providing support for directional antennas at the UAVs are also being added.

So far in 3GPP the UAV communications mostly concern the Uu interface (i.e., UL and downlink (DL)), but in the coming releases starting from Rel-18, the UAV communications in the PC5 (i.e., sidelink) interface will also be standardized. PC5-based UAV communication can be used for broadcasting the UAV identifier (UAV ID) or for the purpose of detect and avoid (DAA).

### Unmanned Aircraft Systems (UAS) Traffic Management (UTM)

It is important to keep the airspace safe and accessible. Therefore, a system called UTM is being developed in different parts of the world to manage the traffic of the UAS (a UAS is composed of a UAV and a UAV controller used by an operator with unique credentials and identities.) According to National Aeronautics and Space Administration (NASA), UTM is a collaborative, automated, and federated airspace management approach that enables safe, efficient, and equitable small UAS operations at scale. The concept of UTM is being adopted and implemented by many countries and regions in the world such as, for example, US, Europe, Japan, Australia, etc. The equivalent of UTM in Europe is called U-Space.

The UTM provides many flight-related functions for UAVs and UAV operators. Some examples include:
Remote identification: enabling UAV identification.
Operation planning: flight planning considering various aspects e.g., UAV performance, whether condition.
Operator messaging: message exchange between operators for e.g., position and status information.
Federal Aviation Administration (FAA) messaging: providing on-demand, periodic, or event-triggered communications with FAA systems to meet regulatory requirements.
Mapping: information about airspace restrictions, obstacles, and sensitive regions.
Conflict advisory: real-time alerting for collision avoidance.
   See, M. Mozaffari, X. Lin, and S. Hayes, “Towards 6G with Connected Sky: UAVs and Beyond,” https://ieeexplore.ieee.org/document/9681624, last visited Aug. 8, 2023.

Mobile networks can enable reliable connectivity between the UAV and its controller. Meanwhile, UTM can connect to the UAV and the UAV controller through the core network and the radio access network. FIG. 1 illustrates an example of UAS-to-UTM connectivity.

### Restricted Areas for UAV Communications

There are many areas where the operation of UAVs is prohibited or limited due to aeronautical regulations or spectrum compatibility due to coexistence with services using adjacent (or other) frequency bands. One type of such areas is the so-called no-transmit zone (NTZ), sometimes also referred to as no-fly zone (NFZ), in which there are restrictions to the UAV communications. For example, in a certain radius around a base station, radio UAV communication needs to be restricted to control the amount of interference to the base station. The NTZ can be imposed on a long-term basis or imposed temporarily, for example, due to a maintenance work of a base station, an ongoing deployment of base station, or a live testing.

Typically, when entering NTZ, the UAV may have to stop operation or lowers its radio transmit power to meet radio emission requirements specified by the regulatory organization in different regions, which include, for example, the European Conference of Postal and Telecommunications Administrations (CEPT), the Association of Radio Industries and Businesses (ARIB), the Federal Communications Commission (FCC), etc. Examples of radio emission requirements are out of band emissions such as spectrum emission mask, spurious emission, etc. A no-transmit zone may comprise a property indicating whether it is allowed or not allowed to transmit radio signals in the zone. For example, the UAV may be allowed to fly within the zone, but the UAV may not be allowed to transmit radio signals within that zone. If the UAV is allowed to transmit radio signals in a zone, the UAV may be limited to certain radio resources such as, for example, certain frequency bands, etc.

There currently exist certain challenge(s), however. For example, as discussed above, radio-restricted areas impose many limitations to the UAV with respect to transmitting and/or receiving radio signals. As a result, UAV communications may not be reliable enough for safe and efficient operation. This will greatly limit the coverage or range of operation of the UAV and, consequently, limit the scenarios where the UAV can be used practically. Therefore, solutions for these situations are needed.

### SUMMARY

Certain aspects of the disclosure and their embodiments may provide solutions to these or other challenges. For example, methods and systems are provided for enabling an arial UE (AUE) and/or the network to detect that the AUE is in proximity of a radio-restricted zone and performing actions at the AUE/network to ensure that the AUE communication quality is not compromised. The signaling between the AUE and the network triggered by such detection is an important aspect.

According to certain embodiments, a method by a UE for communicating in a restricted zone includes determining a location of the UE in relation to the restricted zone. Based on the location of the UE in relation to the restricted zone, the UE takes at least one action to maintain a level of communication quality of the UE.

According to certain embodiments, a UE is provided for communicating in a restricted zone. The UE includes processing circuitry configured to determine a location of the UE in relation to the restricted zone. Based on the location of the UE in relation to the restricted zone, the processing circuitry is configured to take at least one action to maintain a level of communication quality of the UE.

According to certain embodiments, a method by a network node for enabling communication of a UE in a restricted zone includes receiving, from the UE, information indicating a location of the UE in relation to the restricted zone. Based on the location of the UE in relation to the restricted zone, the network node takes at least one action to maintain a level of communication quality of the UE.

According to certain embodiments, a network node is provided for enabling communication of a UE in a restricted zone. The network node includes processing circuitry configured to receive, from the UE, information indicating a location of the UE in relation to the restricted zone. Based on the location of the UE in relation to the restricted zone, the processing circuitry is configured to take at least one action to maintain a level of communication quality of the UE.

Certain embodiments may provide one or more of the following technical advantage(s). For example, certain embodiments may provide a technical advantage of enabling UAV communication in radio-restricted areas, thereby maintaining safe and reliable UAV operation.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of UAS-to-UTM connectivity;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates a method by a UE for communicating in a restricted zone, according to certain embodiments; and

FIG. 9 illustrates a method by a network node for enabling communication of a UE in a restricted zone, according to certain embodiments.

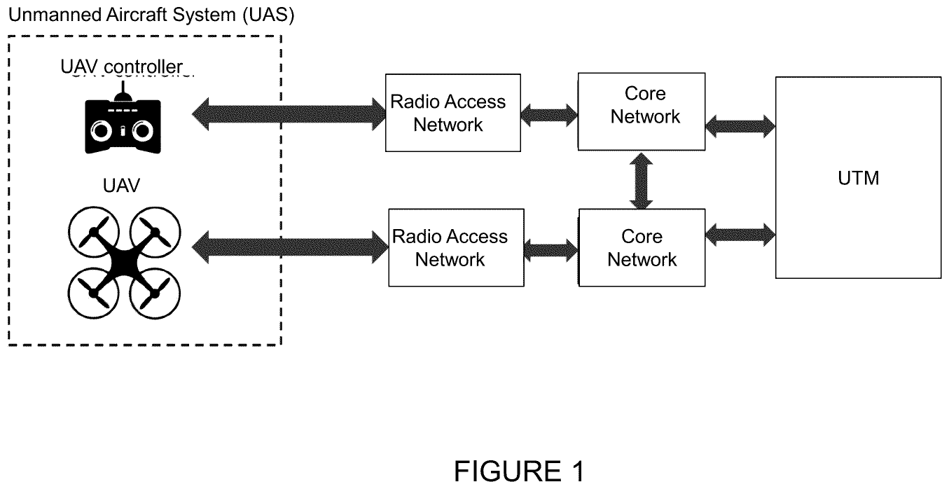

### DETAILED DESCRIPTION

Some of the embodiments contemplated herein will now be described more fully with reference to the accompanying drawings. Embodiments are provided by way of example to convey the scope of the subject matter to those skilled in the art.

Certain embodiments disclosed herein relate to UAV communications in cellular networks. However, the disclosed solutions can be applied to any scenario in which a flying communication device wants to communicate with a control node or access point etc. Furthermore, the disclosed solutions are applicable to direct UE-to-UE communication (e.g., using the PC5 or Sidelink interface).

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), a network node belonging to a Master Cell Group (MCG) or Secondary Cell Group (SCG), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is UE, which is a non-limiting term and refers to any type of wireless device communicating with a network node and/or with another UE in a cellular or mobile communication system. Examples of UE are target device, device to device (D2D) UE, machine type UE, machine type communications UE (MTC UE) or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, Proximity Services UE (ProSe UE), vehicular to vehicular UE (V2V UE), vehicular to anything UE (V2X UE), eMTC UE, FeMTC UE, UE Cat 0, UE Cat M1, narrowband Internet of Things (NB-IoT) UE, UE Cat NB1, etc.

As used herein, the term UE is used, in some particular embodiments, to specifically refer to an AUE (e.g., a UE which is integrated in or attached to a UAV or to other flying vehicles such as flying taxi/bus, helicopter, chopper, airplane, drone, flying balloon, glider, etc.). In general, AUE refers to any type of UE equipped or housed or located in any type of flying object. The flying object moves or flies in air or in free space. The term flying object may be interchangeably called a flying vehicle, aerial vehicle, aerial object, aerial device, IAB node, etc. However, though the terms UE and AUE are used interchangeably herein, it is recognized that the solutions and techniques used herein may be applicable to UEs other than AUEs.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g., in a gNB), Distributed Unit (e.g., in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node, or radio network node may be capable of supporting a single or multiple RATs.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle, etc.

According to certain embodiments, an example scenario includes a UE (e.g., AUE), which is served or managed by at least one serving cell (e.g., a first cell (Cell1)). Cell1 is further managed or served or operated by a network node (e.g., a base station, etc.). Cell1 may further operate on or belong to a first carrier frequency (F1). F1 may further belong to or part of certain frequency band, (e.g., frequency band A or simply band A). The term carrier frequency may also be called as simply carrier, component carrier, layer, frequency layer, etc.

According to certain embodiments, a network node (e.g., an eNB or a gNB) configures a UE with a restricted zone, which may also be interchangeably referred to as a radio-restricted zone or a no-transmit zone or area or region or location. For consistency reasons, the term zone is mainly or mostly used, hereinafter, to refer collectively to a restricted zone, a radio-restricted zone, and/or a no-transmit zone or area or region or location.

As used herein, a zone comprises a geographical area/volume which can be one or multi-dimensional. The zone may be defined by or is characterized by a set of geographical coordinates such as, for example, distance from reference point, set of 2-dimensional coordinates, set of 3-dimensional coordinates in Euclidean space, etc. Within the configured zone, in one example, the network node may not allow UE operation on certain frequency or part of frequency (e.g., on certain portion of the bandwidth) or spectrum band or part of spectrum band. In another example, within the configured zone, the UE operation may be allowed on certain frequency or part of frequency (e.g., on certain portion of the bandwidth) or spectrum band or part of spectrum band provided that the UE radio emissions are restricted (e.g., unwanted emission power or out of band emission power is below certain threshold). In another example, the zone may be an area/volume where a UE cannot transmit in a specific band or part thereof when it cannot fulfill a specific requirement such as, for example, OBUE/spurious emissions, while the UE can transmit outside the zone when it can fulfill the requirements.

In a particular embodiment, the zone can be larger than the actual no-transmit zone by a certain margin.

According to certain embodiments, for example, an AUE served by a first cell (Cell1) determines whether the AUE is within proximity of/to a restricted zone. In a particular embodiment, the determination may performed periodically. In another embodiment, the determination may be made based on message received from a network node. In still another particular embodiment, the determination may be made upon triggering one or more conditions or criteria have been fulfilled.

According to certain embodiments, upon determining and/or detecting that the AUE is within proximity to the restricted zone, the AUE determines whether or that the AUE is entering or about to enter or is inside the restricted zone. The AUE then informs the network node that the AUE is entering or about to enter or is inside the restricted zone. In a particular embodiment, the AUE may further request the network node to perform a cell change (e.g., handover) of the AUE to another cell (e.g., Cell2) on a carrier frequency or frequency band that is different than that of the current serving cell (e.g., Cell1). In another particular embodiment, the AUE may autonomously perform the cell change (e.g., cell reselection) to another cell (e.g., Cell2) on a carrier frequency or frequency band that is different than those of the current serving cell (e.g., Cell1). According to certain embodiments, the AUE may further inform the server managing AUEs (e.g., UTM) that the AUE is entering or about to enter or is inside the restricted zone. The AUE may further obtain information about new trajectory from the server managing the AUEs.

According to certain other embodiments, upon determining and/or detecting that the AUE is within proximity to the restricted zone, the AUE may determine whether or that the UE is leaving or about to leave or has left the restricted zone. The AUE then informs the network node that the AUE is leaving or about to leave or has left the restricted zone. In a particular embodiment, the AUE may request the network node to perform a cell change (e.g., handover) to another cell (e.g., Cell2) on a carrier frequency or frequency band that is different than that of the current serving cell (e.g., Cell1). In another particular embodiment, the AUE may autonomously perform cell change (e.g., cell reselection) to another cell (e.g., Cell2) on a carrier frequency or frequency band that is different than that of the current serving cell (e.g., Cell1). According to certain embodiments, the AUE may further inform the server managing AUEs (e.g., UTM) that the AUE is leaving or about to leave or has left the restricted zone. The AUE may further obtain information about new trajectory from the server managing the AUEs.

### Mechanisms to Determine UE Being in Proximity to the Restricted Zone

According to certain embodiments, the UE determines or detects or identifies whether or that the UE is in the proximity to the restricted zone. According to various particular embodiments, the determination of the UE as being within proximity to the restricted zone may be based on one or more of the following principles:
Periodically, e.g., once every L1 seconds, once every L2 number of time resources (e.g., once every L2 number of frames, etc.), L3 number of DRX cycles, L4 number of extended DRX (eDRX) cycles, etc.
Upon receiving an explicit indication or request from a network node (e.g., NW1) such as, for example, based on a message received from Cell1 asking the UE to determine whether the UE is in the proximity to the restricted zone.
The UE may trigger the determination provided one or more conditions or criteria are met. Examples of criteria to trigger the determination whether the UE is in the proximity to the restricted zone are:
   When the received signal level measured by the UE on signals of a cell (e.g., Cell1) changes by certain margin (M1) such as, for example, a magnitude of the change in the signal level is larger than M1. Examples of the UE's received signal level are: received signal strength (RSS), received signal quality (RSQ), etc. Examples of RSS are RSRP, path loss, etc. Examples of RSQ are RSRQ, Signal to Noise Ratio (SNR), Signal Interference to Noise Ratio (SINR), etc.
   When the UE's received signal level becomes larger than certain threshold (H1).
   When the UE's received signal level becomes smaller than certain threshold (H2).
   When the UE's received signal level differs with respect to a reference UE received signal level by certain threshold (H3). Examples of the reference UE received signal are UE received signal measured on a cell other than Cell1 such as, for example, on a second cell (Cell2). In one example, Cell2 is a neighbor cell. In another example, Cell2 is a secondary cell (e.g., SCell).
   When the UE location changes by certain margin (M2) such as, for example, a magnitude of the change in the location is larger than M2. The UE determines its location and change in its location based on one or more positioning methods such as, for example, Global Navigation Satellite System (GNSS), enhanced cell identifier (ID), Observed Time Difference of Arrival (OTDOA), etc.
   When the UE location changes by certain margin (M3) within certain time period (T1) such as, for example, a magnitude of the change in the location is larger than M2 during T1.
If the UE has early determined that it is in the proximity to the restricted zone or has moved inside or outside the restricted zone. In this case the purpose may be to determine whether the UE remains in the restricted zone or has left the restricted zone or is leaving or about to leave the restricted zone. The restricted zone in this case may be applicable for carrier frequency F1 or a different carrier frequency.

The parameters L1, L2, L3, L4, M1, M2, M3, H1, H2 and T1 can be pre-defined and/or configured by a network node, in particular embodiments.

In a particular embodiment, the UE determines whether or that it is in the proximity to the restricted zone by comparing its current location (e.g., geographical coordinates) with a set of geographical coordinates defining the restricted zone. For example, if the magnitude of the distance between the current UE location and the boundary of the restricted zone is less than certain margin then the UE is considered to be in the proximity to the restricted zone; otherwise, the UE is not considered to be in the proximity to the restricted zone.

### UE Procedure Upon Entering the Restricted Zone

When the UE is in the proximity to the restricted zone such as, for example, when the UE is entering or about to enter the zone or has just entered the restricted zone, the UE can perform at least one of the following actions:
The UE sends an indication to the network node via signalling message, such as, for example, Radio Resource Control (RRC), Medium Access Control-Control Element (MAC-CE), or Physical Layer (PHY-layer) signalling.
   For example, in particular embodiments, the UE indicates at least of one of:
      its current location (e.g., geographical coordinates, identifier of one or pre-defined or pre-configured locations, height, etc.),
      planned trajectory (e.g., set of geographical coordinates, identifier of one or pre-defined or pre-configured trajectories, etc.).
   As another example, in particular embodiments, the UE indicates that it is entering or is expected to enter the restricted zone in the next N1 time units (e.g., N1 seconds) and/or N2 time resources (e.g., N2 number of slots, N2 number of subframes, N2 number of frames, etc.). In a particular embodiment, the UE may further indicate a reference time (Tr) from when onwards the UE is entering or is expected to enter the restricted zone in the next N1 time units and/or N2 time resources. Examples of Tr are current time (i.e., when the message is sent), certain universal time (e.g., UTC time), frame or cell timing (e.g., SFN such as SFN #64, etc.), etc.
In a particular embodiment, the UE may further optionally initiate a cell change procedure. Examples of cell change procedures are handover, cell selection, cell reselection, RRC connection release with redirection, RRC connection re-establishment, etc. The UE may initiate the cell change procedure in any of low activity RRC state (e.g., idle state or inactive state) and high activity RRC state (e.g., connected state). The rational of this type of indication is that it might relax the requirement for the network to always be fully aware where each UE may be served as it is in the first place the AUE that is supposed to have this information. However, it may become to be stated as a network requirement, and this would be beneficial to lift such a network requirement. Examples of the cell change procedure which can be initiated or performed by the UE are:
   Transmitting hand-over (HO) request to the network node and/or to a further network node so that the UE is handed over to a cell belonging to another frequency band or carrier that is supported by either of or both of the network nodes. For example, the UE operating in band A, upon entering or before entering the zone, requests the network node to handover to a cell on band B. As another example, UE is able to determine based on angle of arrival of the reference signal it is measuring, which cell likely has coverage around, no fly-zone, the margin area, or area where UE does not have flying restrictions.
      The HO request may be in the form of a measurement report message/indication. The UE may have a measurement report trigger, that is executed or becomes fulfilled in response to entering or being about to enter the zone. This may be an event based on location or it may be an event based on named cells/PCIs and RSRP above a configured threshold being triggering simultaneously.
   Transmitting a measurement result where UE flags RSRP results belonging to a cell that belongs to a no-transmit zone, in the margin area, or the area where UE does not have restrictions. Or, UE may flag this based on the frequency band of the measured cell.
   Autonomously perform a cell change to another cell (e.g., to Cell2). In one example, the UE operating in Cell1 on band A performs cell change to a cell on another band e.g., to the cell on band B.
      This may be implemented by the UE giving a certain (low) priority to the frequency that is associated with the no-fly zone. The UE would, in this way ensure, that the UE would not use the frequency if there are other (higher priority) frequencies available However if there is no other candidate frequency available, the UE may still use the frequency associated with the no fly zone. This may be beneficial in case the UE should not lose service completely due to the no-fly zone.
      Another approach is that the UE does not consider the frequencies associated with the no-fly zone as candidates at all. This may be beneficial in case the reason for the no-fly zone is to protect some communication which cannot be disturbed at all by the UE.
   In the above examples of cell change procedures, the UE determines carrier frequency and/or the band (e.g., band B) of the target cell based on any of the following principles:
      In one example, the UE is pre-configured with the carrier frequency and/or the band of the target cell e.g., pre-configured by the network node by signalling such as RRC message, etc.
      In another example, the UE autonomously select the carrier frequency and/or the band of the target cell.
      In another example, the UE is pre-configured with a set of carrier frequencies (Sf) and/or a set of bands (Sb) for the target cell. The UE autonomously selects the carrier frequency out of the set Sf and/or the band out of set Sb of the target cell.

Based on the indication received from the UE, in various particular embodiments, the network node can perform one or more of the following actions:
The network node initiates a cell change (e.g., HO) of the UE to a second cell (Cell2) on another carrier frequency e.g., from F1 to a second carrier frequency (F2). F2 may belong to the same band as of F1 or to a different band.
The network node initiates a cell change (e.g., HO) of the UE to Cell2 on another frequency band e.g., from band A to band B.
The network node controls one or more parameters related to beamforming of signals at the UE. For example, in a particular embodiment, the network node instructs the UE to narrow or widen the transmit beam from the UE and/or to steer the beams to certain directions to reduce the radiation impact on the affected area. A beam may be characterized or defined by one or more parameters namely beamwidth (e.g., Y1 degrees within which beam power is Y2 dB below max beam power), beam direction (e.g., Y3 degrees with regard to reference direction), beam range (e.g., 4 meters from the UE location), etc. For example, in a particular embodiment, when the UE is in the proximity to the restricted zone, the UE is requested to perform one or more of the following with regard to UE's beamforming:
   UE to use narrower beam for transmitting signals (e.g., narrower beam than current beam, beam with beamwidth smaller than certain threshold, etc.).
   UE to change the direction of the beam (e.g., away from the restricted zone).
The network node controls the UE to reduce the UE's transmit power such as, for example, by means of open loop or closed loop power control. In the open loop power control, the UE autonomously adjusts its transmit power (increase or decrease) based on e.g., path loss or received signal measured with respect to the serving cell. In the closed loop power control, the UE adjusts its transmit power (e.g., increase or decrease) based on a command or message received from the network node. For example, in various particular embodiments, the UE may be instructed to reduce its transmit power according to one or more of the following principles:
   reduce by certain margin compared to the current transmit power (e.g., by X1 dB),
   reduce below certain threshold (e.g., below X2 dBm),
   reduce to a reference value (Pr) (e.g., Pr may be pre-defined value, pre-configured value, minimum power level of the UE, etc.)
The network node configures and/or modifies the DRX configuration and/or activates a new DRX configuration in the UE so that the DRX Inactive time in increased. In one example,, the new or the modified DRX cycle may be longer than the current DRX cycle of the UE. In one example embodiment, the DRX cycle (e.g., length of DRX cycle) is changed from 320 ms to 1280 ms. In one example, the DRX active time (e.g., ON duration) of the DRX cycle is changed from 10 ms to 1 ms. During the DRX inactive time (e.g., OFF period), the UE does not monitor the DL channel (e.g., DL control channel such as PDCCH) in the serving cell). Thus, for example, the UD does not monitor the DL channel during the inactive time so that the UE can save its battery power. During the DRX active time, the UE has to monitor the DL channel (e.g., DL control channel such as PDCCH) in the serving cell.
The network node may temporarily turn off the UE's communication on the sidelink interface (e.g., PC5 interface) or reduce the UE's transmission rate in that interface.
While the network node can configure/modify the UE for operating in a specific band (for example, Band A) in UL according to certain particular embodiments, the network node can use the same band (i.e., Band A) for downlink without any such restrictions to the specific UE within the zone while using a different band for UL. Conversely, if there is a zone defined where the network cannot transmit towards a UE in the downlink, the band may still be used in UL, in a particular embodiment.
The network node adjusts its transmit and/or receive beamforming parameters and/or transmit power to compensate for the reduced radiated power at the UE side in the restricted zone. For example, in a particular embodiment, when the UE transmit power is below certain threshold, the network may adapt to increase the receive beamforming gain at the network side, so that the signal from the UE is received at sufficient power at the network node.

In a particular embodiment, in case the UE or the network node initiates a HO to a further network node, the UE or the network node can inform the further network node about the purpose of the HO (e.g., because the UE is entering a restricted area.)

In another particular embodiment, if the restricted zone is defined for one or more bands (e.g., band B) and the UE is connected to the network using band A that does not have such restrictions, the UE or network node may perform the abovementioned actions when entering or leaving the restricted zone for band B. For example, based on the UE report, the network does not hand-over the UE to the band B when the UE is in the restricted zone (and the network removes that restriction when the UE has left the restricted zone of band B).

In another particular embodiment, the UE may further inform the server or node managing AUEs (e.g., UTM) that the UE is entering a radio-restricted zone. The information may also include the types of actions that the cellular network will apply on the UE when the UE enters the zone.
The server or node managing AUEs (e.g., UTM) may perform some actions based on this information., For example, UTM may configure the UAV with a new trajectory.
The UE configured with the new trajectory may suspend the old or current trajectory and instead start moving according to the new trajectory configured by the server or node managing AUEs.

### Considerations of Users and Services

Certain procedures have been described above that include the UE and network taking actions in response to a UE entering or is about to enter a no fly zone. In a further particular embodiment, the UE or networks considers the type of the UE when determining whether to take the actions described herein.

For example, in a particular embodiment, the type of the UE may be determined based on a feature of the UE such as capabilities of the UE. As another example, the type of the UE may be determined based on the user of the UE. For example, special users (e.g., police) may be considered higher priority than other users and may be allowed to fly or communicate within the zone while other UEs are not. This may be achieved by means of determining the subscription of the UE. For example, special UEs (e.g., police) may have a special subscription that can be used to determine whether the user of the UE is a special UE or not.

In another particular embodiment, the services that the UE is using is considered when determining whether to apply the methods described herein. Certain services may be considered of high importance and, thus, would be allowed to be used within the zone. For example, emergency services may be allowed even when within the zone while other services are not. A UE that is using a service of high importance may be allowed to communicate within the zone, while UEs using other (low importance) services may not. Thus, the UE may determine which services the UE is using when determining whether to take one or more of the actions described herein. In one embodiment, the UE may refrain from using services that are of low importance when within the zone (or while using the frequencies associated with the zone).

### UE Procedure Upon Leaving the Restricted Zone

According to certain embodiments, the UE sends an indication (e.g., RRC message, etc.) to a network node when the UE is leaving or about to leave a configured restricted zone or area. If the UE is not in the proximity of the restricted zone, then the UE is considered to be leaving or is about to leave or considered to have left the configured restricted zone.

According to certain embodiments, based on the received indication, the network node may perform one or more actions. For example, the network node may initiate a HO of the UE to another frequency band or carrier that is not prohibited/restricted outside the restricted zone. As another example, the network node may control the beamforming and/or Tx power of the UE to before the UE enters the restricted zone.

In a particular embodiment, the UE may further (optionally) autonomously perform cell change to any cell that is allowed for the cell change such as, for example, a cell on any carrier frequency configured for a cell change procedure (e.g., for cell selection, cell reselection, etc.).

In another particular embodiment, the UE may further inform the server or node managing AUEs (e.g., UTM) that the UE is leaving or about to leave a radio-restricted zone. The information may also include the types of actions that the cellular network will apply on the UE when the UE leaves the zone.

According to certain embodiments, the server or node managing AUEs (e.g., UTM) may perform some actions based on this information. For example, UTM may configure the UAV with a new trajectory or request the UE to use a previously configured trajectory or default trajectory.

According to certain embodiments, the UE may suspend the old or current trajectory and instead the UE may start moving according to the new trajectory configured by the server or node managing AUEs.

### UE Procedure when the Restricted Zone is Based on UE Capability

In a particular embodiment, a UE may have to fulfill a specific requirement (e.g., Out-of-Band Unwanted Emission (OBUE)/Spurious emissions requirement) but may be able to do so only within/outside a specific area/volume, resulting in a restricted zone for a specific band. Thus, the UE may perform the procedures described above when it is entering or leaving a zone where it cannot transmit, as it will not be able to fulfill the requirements.

As an example, inside a zone, a combination of poor propagation condition (e.g., Non-Line-of-Sight (N-LoS) condition) and a limited transmit power to fulfill the OBUE requirements makes the UAV communication impossible or unreliable. In contrast, outside of the zone, thanks to more favorable propagation condition (e.g., Line-of-Sign (LoS) condition), the same transmit power that fulfills the OBUE requirements can achieve reliable communication.

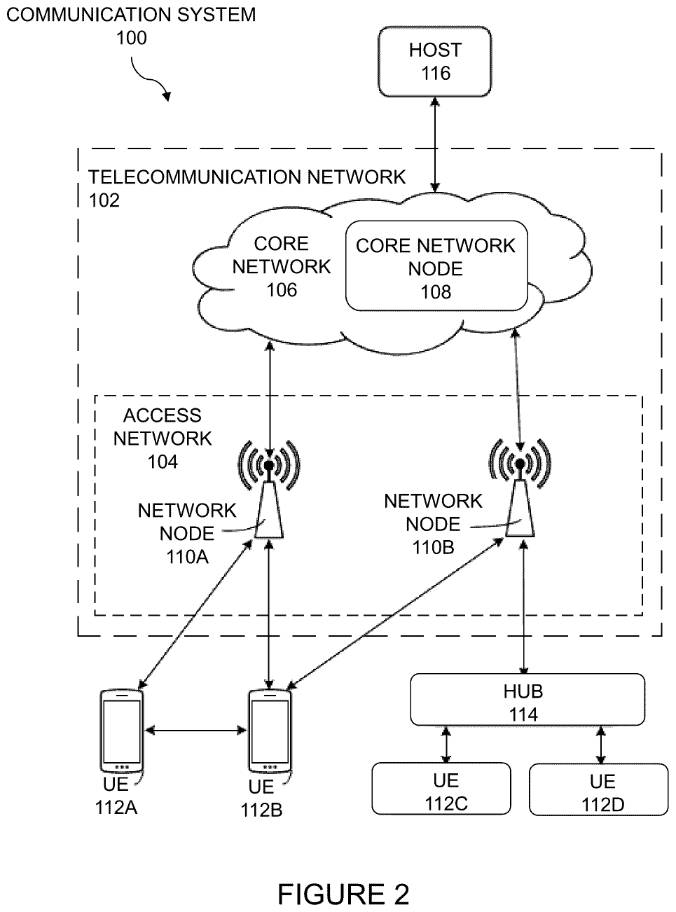

FIG. 2 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

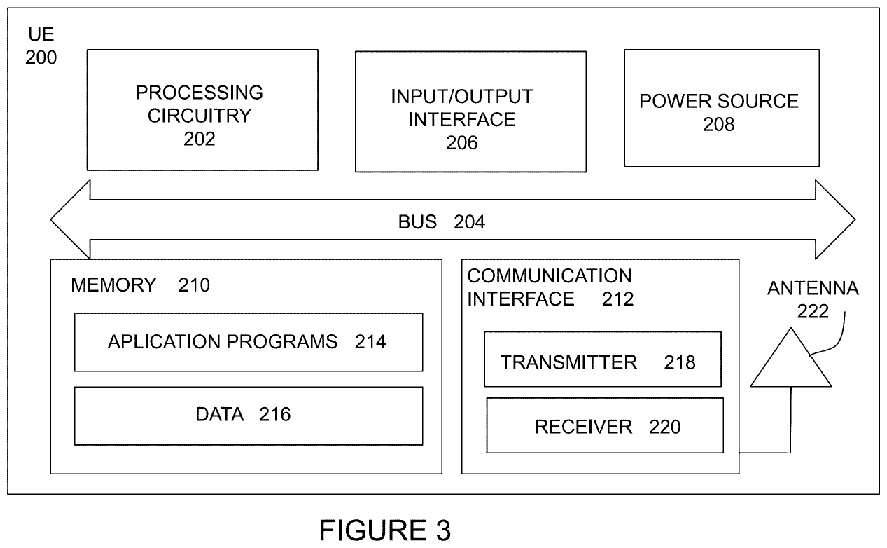

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

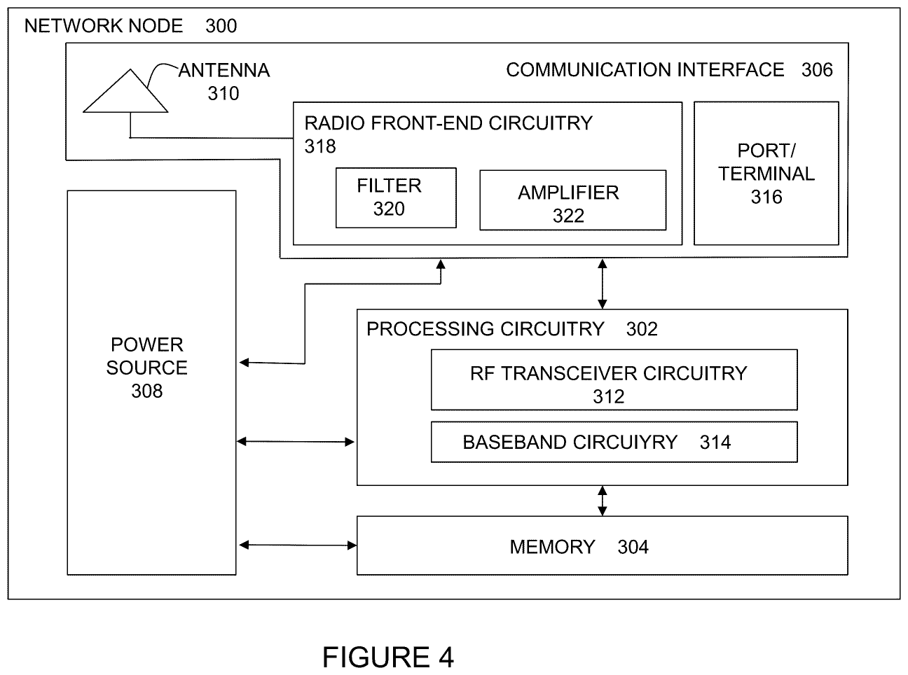

FIG. 4 shows a network node 300 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

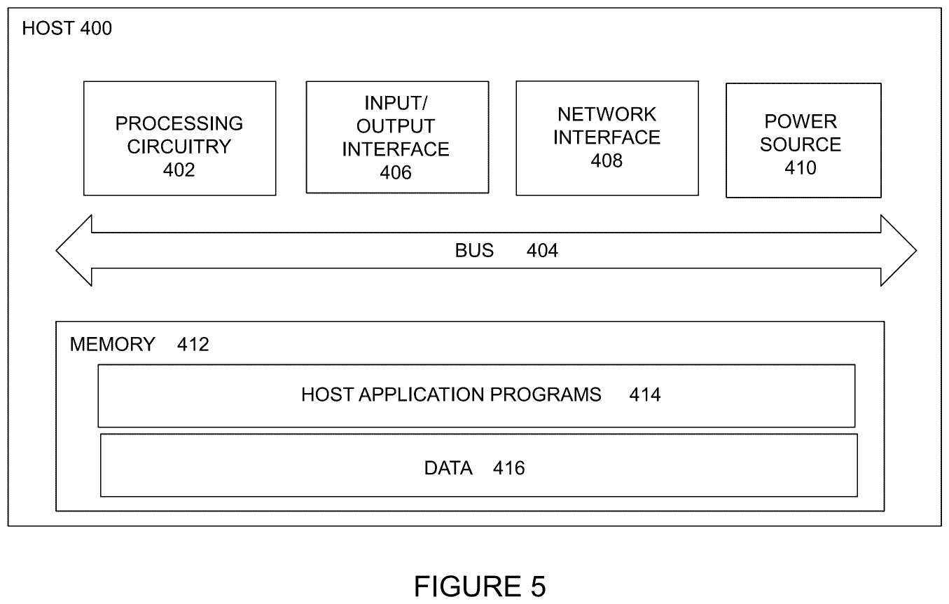

FIG. 5 is a block diagram of a host 400, which may be an embodiment of the host 116 of FIG. 2, in accordance with various aspects described herein.

As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

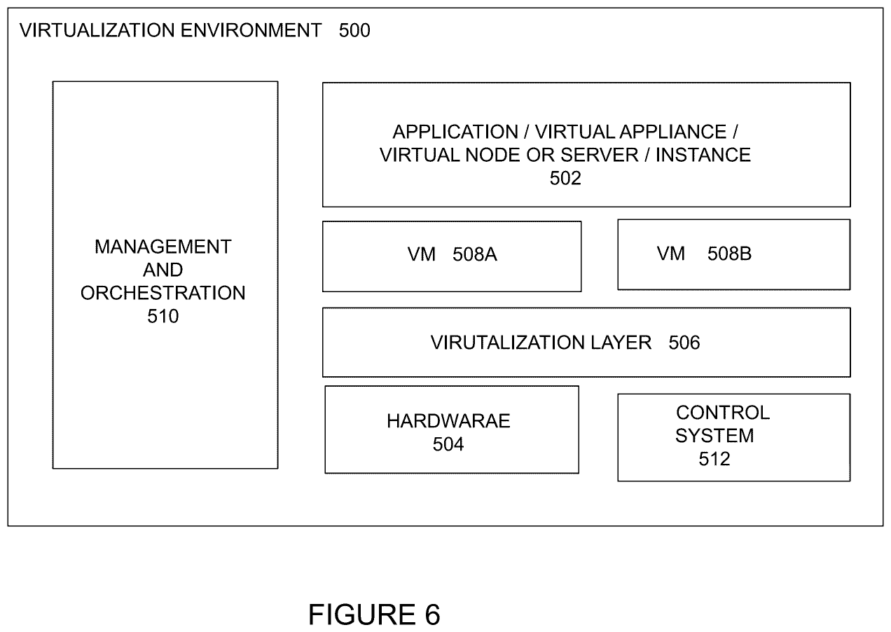

FIG. 6 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

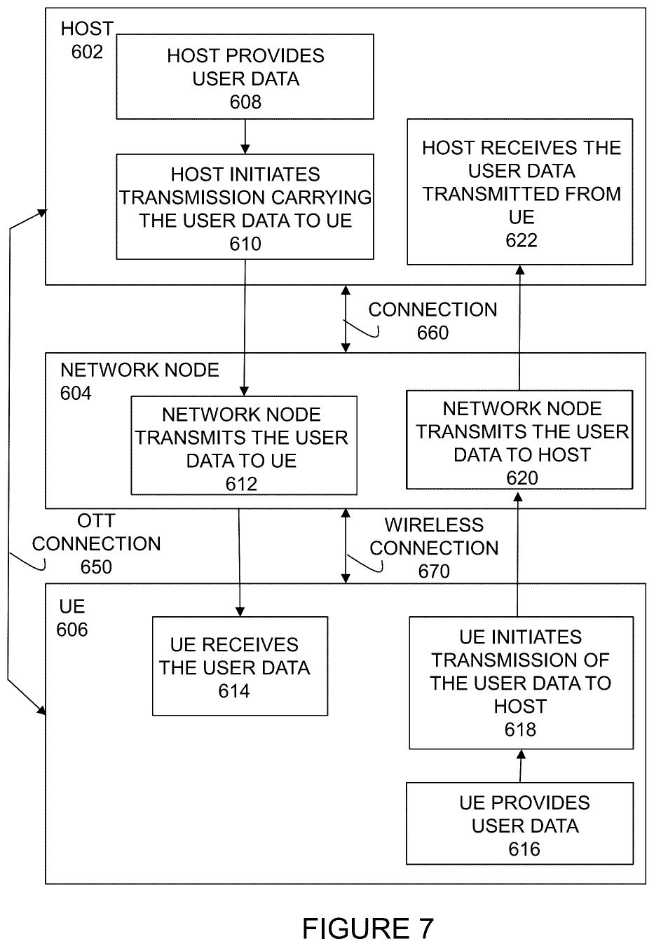

FIG. 7 shows a communication diagram of a host 602 communicating via a network node 604 with a UE 606 over a partially wireless connection in accordance with some embodiments.

Example implementations, in accordance with various embodiments, of the UE (such as a UE 112a of FIG. 2 and/or UE 200 of FIG. 3), network node (such as network node 110a of FIG. 2 and/or network node 300 of FIG. 4), and host (such as host 116 of FIG. 2 and/or host 400 of FIG. 5) discussed in the preceding paragraphs will now be described with reference to FIG. 7.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

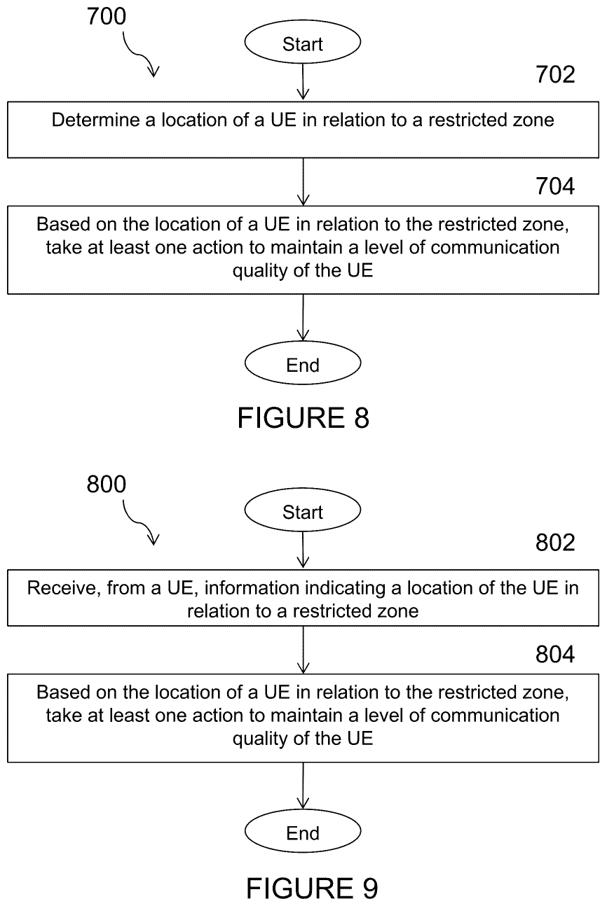

FIG. 8 illustrates a method 700 by a UE 112 for communicating in a restricted zone, according to certain embodiments. In the example embodiment, the method begins at step 702 when the UE 112 determines a location of the UE in relation to the restricted zone. Based on the location of the UE in relation to the restricted zone, the UE 112 takes at least one action to maintain a level of communication quality of the UE, at step 704.

In a particular embodiment, when determining the location of the UE 112 in relation to the restricted zone, the UE 112 determines that the location of the UE 112 is within proximity of the restricted zone.

In a particular embodiment, determining that the location of the UE 112 is within proximity of the restricted zone includes determining that a distance between the location of the UE 112 and the restricted zone is less than a threshold amount and/or comparing at least one geographical coordinate associated with the location of the UE 112 to at least one of geographical coordinate associated with the restricted zone.

In a particular embodiment, the step of determining the location of the UE 112 in relation to the restricted zone is performed periodically.

In a particular embodiment, the UE 112 receives, from a network node 110 associated with a first cell in which the UE 112 is served, a message indicating that the UE 112 is to determine the location of the UE 112 in relation to the restricted zone. The location of the UE in relation to the restricted zone is determined in response to the message.

In a particular embodiment, the UE 112 determines that a condition has been fulfilled or that an event has occurred, and the location of the UE 112 in relation to the restricted zone is determined based on the condition being fulfilled or the event having occurred.

In a further particular embodiment, determining that the condition has been fulfilled or that an event has occurred includes at least one of: determining that at least one measured signal level has changed by more than a first threshold amount; determining that at least one measured signal level is more than a second threshold amount; determining that at least one measured signal level is less than a third threshold amount; determining that at least one measured signal level differs from a reference value by more than a fourth threshold amount; determining that the location of the UE has changed by more than a fifth threshold amount; and determining that the location of the UE has changed by more than a sixth threshold amount within a period of time.

In a particular embodiment, determining the location of the UE 112 in relation to the restricted zone includes at least one of: determining that the UE 112 is entering the restricted zone; determining that the UE 112 may enter or will enter or is projected to enter the restricted zone within a range of time; and determining that the UE 112 is in the restricted zone.

In a further particular embodiment, taking the at least one action to maintain the level of communication quality of the UE 112 includes transmitting a message to a network node. The message includes at least one of: information that indicates that the UE 112 is entering or is in the restricted zone; information that indicates that the UE 112 is about to enter the restricted zone; information that indicates that the UE 112 may enter or will enter or is projected to enter the restricted zone within a number of time units and/or time resources; information that indicates that the UE 112 may enter or will enter or is projected to enter the restricted zone at an expected time or in an expected time resource; information that indicates the location of the UE 112; and information indicating a planned trajectory of the UE 112.

In a particular embodiment, determining the location of the UE 112 in relation to the restricted zone comprises at least one of: determining that the UE 112 is leaving the restricted zone; determining that the UE 112 may leave or will leave or is projected to leave the restricted zone; and determining that the UE 112 is not in the restricted zone.

In a further particular embodiment, taking the at least one action to maintain the level of communication quality of the UE 112 includes transmitting a message to a network node, and wherein the message comprises at least one of: information that indicates that the UE 112 is leaving or is not in the restricted zone; information that indicates that the UE 112 may leave or will leave or is projected to leave the restricted zone within a number of time units and/or time resources; information that indicates that the UE 112 may leave or will leave or is projected to leave the restricted zone at an expected time or in an expected time resource; information that indicates the location of the UE 112; and information indicating a planned trajectory of the UE 112.

In a particular embodiment, taking the at least one action to maintain the level of communication quality of the UE 112 includes transmitting, to a network node 110 serving the UE 112 in a first cell, a message to initiate a cell change procedure, and/or initiating, at the UE 112, a cell change procedure to change from a first cell to a second cell.

In a further particular embodiment, the first cell is associated with a first carrier frequency and the second cell is associated with a second carrier frequency and/or the first cell is associated with a first frequency band and the second cell is associated with a second frequency band.

In a particular embodiment, the UE 112 receives, from a network node 110, information that indicates a new trajectory or a modified trajectory for the UE 112.

In a particular embodiment, the UE 112 determines a characteristic associated with the UE 112, and the at least one action is taken based at least in part on the characteristic associated with the UE 112. The characteristic includes at least one of: a type of the UE 112, a capability of the UE 112, a type of a user of the UE 112, and a priority level of the UE 112.

FIG. 9 illustrates a method 800 by a network node 110 for enabling communication of a UE 112 in a restricted zone, according to certain embodiments. In the depicted example embodiment, the method begins at step 802 when the network node 110 receives, from the UE 112, information indicating a location of the UE 112 in relation to the restricted zone. Based on the location of the UE 112 in relation to the restricted zone, the network node 110 takes at least one action to maintain a level of communication quality of the UE 112, at step 804.

In a particular embodiment, the information indicates that the UE 112 is within proximity of the restricted zone.

In a particular embodiment, the information indicates that a distance between the location of the UE 112 and the restricted zone is less than a threshold amount.

In a particular embodiment, the network node 110 is serving the UE 112 in a first cell, and the network node 110 transmits, to the UE 112, a message to trigger the UE 112 to determine the location of the UE 112 in relation to the restricted zone.

In a particular embodiment, the network node 110 configures the UE 112 to monitor for a fulfillment of a condition or an occurrence of an event, and the location of the UE 112 in relation to the restricted zone is determined based on the condition being fulfilled or the event having occurred.

In a further particular embodiment, the condition is fulfilled or the event has occurred when at least one of: at least one measured signal level has changed by more than a first threshold amount; at least one measured signal level is more than a second threshold amount; at least one measured signal level is less than a third threshold amount; at least one measured signal level differs from a reference value by more than a fourth threshold amount; the location of the UE 112 has changed by more than a fifth threshold amount; and the location of the UE 112 has changed by more than a sixth threshold amount within a period of time.

In a particular embodiment, the information indicates at least one of: the UE 112 is entering the restricted zone; the UE 112 is about to enter the restricted zone; the UE 112 may enter or will enter or is projected to enter the restricted zone within a range of time; the UE 112 may enter or will enter or is projected to enter the restricted zone within a number of time units and/or time resources; the UE 112 may enter or will enter or is projected to enter the restricted zone at an expected time or in an expected time resource; the location of the UE 112; and a planned trajectory of the UE 112.

In a particular embodiment, the information indicates at least one of: the UE 112 is leaving the restricted zone; the UE 112 may leave or will leave or is projected to leave the restricted zone; the UE 112 is not in the restricted zone; the UE 112 may leave or will leave or is projected to leave the restricted zone within a number of time units and/or time resources; the UE 112 may leave or will leave or is projected to leave the restricted zone at an expected time or in an expected time resource; the location of the UE 112; and a planned trajectory of the UE 112.

In a particular embodiment, taking the at least one action includes transmitting, to the UE 112, a message to initiate a cell change procedure to change the from the first cell to a second cell.

In a further particular embodiment, the first cell is associated with a first carrier frequency and the second cell is associated with a second carrier frequency and/or the first cell is associated with a first frequency band and the second cell is associated with a second frequency band.

In a particular embodiment, taking the at least one action includes at least one of: adjusting at least one beamforming parameter to narrow or widen at least one beam transmitted to the UE 112; adjusting a power of a beam transmitted to the UE 112; and adjusting a direction of a beam transmitted to the UE 112.

In a particular embodiment, taking the at least one action includes at least one of: transmitting, to the UE 112, an adjusted transmit power for use by the UE 112 in receiving or transmitting a signal; transmitting, to the UE 112, a new or modified DRX configuration for use by the UE 112 in receiving or transmitting a signal; transmitting, to the UE 112, an indication to turn on a sidelink interface; transmitting, to the UE 112, an indication to turn off a sidelink interface; and transmitting, to the UE 112, an indication to increase or reduce a transmission rate of the UE 112 on a sidelink interface.

In a particular embodiment, taking the at least one action includes transmitting, to the UE 112, information that indicates a new trajectory or a modified trajectory for the UE 112.

In a particular embodiment, the network node 110 determines a characteristic associated with the UE 112, and the at least one action is taken based at least in part on the characteristic associated with the UE 112. The characteristic comprises at least one of: a type of the UE 112, a capability of the UE 112, a type of a user of the UE 112, and a priority level of the UE 112.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for communicating in a restricted zone, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method by a network node for enabling communication of a User Equipment (UE) in a restricted zone, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for communicating in a restricted zone, the method comprising: determining a location of a UE in relation to a restricted zone; and based on the location of a UE in relation to the restricted zone, taking at least one action to maintain a level of communication quality of the UE.

Example Embodiment C2. The method of Example Embodiment C1, wherein determining the location of the UE in relation to the restricted zone comprises determining that the location of the UE is within proximity of the restricted zone.

Example Embodiment C3a. The method of Example Embodiment C2, wherein determining that the location of the UE is within proximity of the restricted zone comprises determining that a distance between the location of the UE and the restricted zone is less than a threshold amount.

Example Embodiment C3b. The method of Example Embodiment C2, wherein determining that the location of the UE is within proximity of the restricted zone comprises comparing at least one geographical coordinate associated with the location of the UE to at least one of geographical coordinate associated with the restricted zone.

Example Embodiment C4a. The method of any one of Example Embodiments C1 to C3b, wherein the step of determining the location of the UE in relation to the restricted zone is performed periodically.

Example Embodiment C4b. The method of any one of Example Embodiments C1 to C3b, comprising: receiving, from a network node associated with a first cell in which the UE is served, a message indicating that the UE is to determine the location of the UE in relation to the restricted zone, and wherein determining the location of the UE in relation to the restricted zone is performed in response to the message.

Example Embodiment C4c. The method of any one of Example Embodiments C1 to C3b, comprising: determining that a condition has been fulfilled or that an event has occurred, and wherein the location of the UE in relation to the restricted zone is determined based on the condition being fulfilled or the event having occurred.

Example Embodiment C4d. The method of Example Embodiment C4c, wherein determining that the condition has been fulfilled or that an event has occurred comprises at least one of: determining that at least one measured signal level has changed by more than a first threshold amount; determining that at least one measured signal level is more than a second threshold amount; determining that at least one measured signal level is less than a third threshold amount; determining that at least one measured signal level differs from a reference value by more than a fourth threshold amount; determining that the location of the UE has changed by more than a fifth threshold amount; and determining that the location of the UE has changed by more than a sixth threshold amount within a period of time.

Example Embodiment C5a. The method of any one of Example Embodiments C1 to C4, wherein determining the location of the UE in relation to the restricted zone comprises at least one of: determining that the UE is entering the restricted zone; determining that the UE may enter or will enter or is projected to enter the restricted zone within a range of time; and determining that the UE is in the restricted zone.

Example Embodiment C5b. The method of Example Embodiment C5a, wherein taking the at least one action to maintain the level of communication quality of the UE comprises transmitting a message to a network node, and wherein the message comprises at least one of: information that indicates that the UE is entering or is in the restricted zone; information that indicates that the UE is about to enter the restricted zone; information that indicates that the UE may enter or will enter or is projected to enter the restricted zone within a number of time units and/or time resources; information that indicates that the UE may enter or will enter or is projected to enter the restricted zone at an expected time or in an expected time resource; information that indicates the location of the UE; and information indicating a planned trajectory of the UE.

Example Embodiment C5c. The method of any one of Example Embodiments C5a to C5b, wherein taking the at least one action to maintain the level of communication quality of the UE comprises transmitting, to a network node serving the UE in a first cell, a message to initiate a cell change procedure.

Example Embodiment C5d. The method of any one of Example Embodiments C5a to C5b, wherein taking the at least one action to maintain the level of communication quality of the UE comprises initiating, at the UE, a cell change procedure to change from a first cell to a second cell.

Example Embodiment C5e. The method of any one of Example Embodiments C5c to C5d, wherein the first cell is associated with a first carrier frequency and the second cell is associated with a second carrier frequency.

Example Embodiment C5f. The method of any one of Example Embodiments C5c to C5d, wherein the first cell is associated with a first frequency band and the second cell is associated with a second frequency band.

Example Embodiment C6a. The method of any one of Example Embodiments C1 to C4, wherein determining the location of the UE in relation to the restricted zone comprises at least one of: determining that the UE is leaving the restricted zone; determining that the UE may leave or will leave or is projected to leave the restricted zone; and determining that the UE is not in the restricted zone.

Example Embodiment C6b. The method of Example Embodiment C6a, wherein taking the at least one action to maintain the level of communication quality of the UE comprises transmitting a message to a network node, and wherein the message comprises at least one of: information that indicates that the UE is leaving or is not in the restricted zone; information that indicates that the UE may leave or will leave or is projected to leave the restricted zone within a number of time units and/or time resources; information that indicates that the UE may leave or will leave or is projected to leave the restricted zone at an expected time or in an expected time resource; information that indicates the location of the UE; and information indicating a planned trajectory of the UE.

Example Embodiment C6c. The method of any one of Example Embodiments C6a to C6b, wherein taking the at least one action to maintain the level of communication quality of the UE comprises transmitting, to a network node serving the UE in a first cell, a message to initiate a cell change procedure.

Example Embodiment C6d. The method of any one of Example Embodiments C6a to C6b, wherein taking the at least one action to maintain the level of communication quality of the UE comprises initiating, at the UE, a cell change procedure to change from a first cell to a second cell.

Example Embodiment C6e. The method of any one of Example Embodiments C5c to C5d, wherein the first cell is associated with a first carrier frequency and the second cell is associated with a second carrier frequency.

Example Embodiment C6f. The method of any one of Example Embodiments C6c to C6d, wherein the first cell is associated with a first frequency band and the second cell is associated with a second frequency band.

Example Embodiment C7. The method of any one of Example Embodiments C1 to C6f, wherein taking the at least one action to maintain the level of communication quality of the UE comprises transmitting, to a network node, information indicating the location of the UE in relation to the restricted zone.

Example Embodiment C8. The method of any one of Example Embodiments C1 to C7, wherein taking the at least one action to maintain the level of communication quality of the UE comprises transmitting, to a server, information indicating the location of the UE in relation to the restricted zone.

Example Embodiment C9. The method of Example Embodiment C8, comprising receiving, from the server, information that indicates a new trajectory or a modified trajectory for the UE.

Example Embodiment C10. The method of any one of Example Embodiments C1 to C9, comprising determining a characteristic associated with the UE, and wherein the at least one action is taken based at least in part on the characteristic associated with the UE.

Example Embodiment C11. The method of Example Embodiment C10, wherein the characteristic comprises at least one of: a type of the UE, a capability of the UE, a type of a user of the UE, and a priority level of the UE.

Example Embodiment C12. The method of Example Embodiments C1 to C11, further comprising: providing user data; and forwarding the user data to a host via the transmission to the network node.

Example Embodiment C13. A user equipment comprising processing circuitry configured to perform any of the methods of Example Embodiments C1 to C12.

Example Embodiment C14. A wireless device comprising processing circuitry configured to perform any of the methods of Example Embodiments C1 to C12.

Example Embodiment C15. A computer program comprising instructions which when executed on a computer perform any of the methods of Example Embodiments C1 to C12.

Example Embodiment C16. A computer program product comprising computer program, the computer program comprising instructions which when executed on a computer perform any of the methods of Example Embodiments C1 to C12.

Example Embodiment C17. A non-transitory computer readable medium storing instructions which when executed by a computer perform any of the methods of Example Embodiments C1 to C12.

### Group D Example Embodiments

Example Embodiment D1. A method by a network node for enabling communication of a User Equipment (UE) in a restricted zone, the method comprising: receiving, from the UE, information indicating a location of a UE in relation to a restricted zone; and based on the location of a UE in relation to the restricted zone, taking at least one action to maintain a level of communication quality of the UE.

Example Embodiment D2. The method of Example Embodiment D1, wherein the information indicates that the UE is within proximity of the restricted zone.

Example Embodiment D3. The method of Example Embodiment D2, wherein the information indicates that a distance between the location of the UE and the restricted zone is less than a threshold amount.

Example Embodiment D4a. The method of any one of Example Embodiments D1 to D3, wherein the network node is serving the UE in a first cell, and the method further comprises: transmitting, to the UE, a message to trigger the UE to determine the location of the UE in relation to the restricted zone.

Example Embodiment D4b. The method of any one of Example Embodiments D1 to D3, comprising configuring the UE to monitor for a fulfillment of a condition or an occurrence of an event, and wherein the location of the UE in relation to the restricted zone is determined based on the condition being fulfilled or the event having occurred.

Example Embodiment D4c. The method of Example Embodiment D4b, wherein the condition is fulfilled or the event has occurred when at least one of: at least one measured signal level has changed by more than a first threshold amount; at least one measured signal level is more than a second threshold amount; at least one measured signal level is less than a third threshold amount; at least one measured signal level differs from a reference value by more than a fourth threshold amount; the location of the UE has changed by more than a fifth threshold amount; and the location of the UE has changed by more than a sixth threshold amount within a period of time.

Example Embodiment D5a. The method of any one of Example Embodiments D1 to D4c, wherein the information indicates at least one of: the UE is entering the restricted zone; the UE is about to enter the restricted zone; the UE may enter or will enter or is projected to enter the restricted zone within a range of time; the UE may enter or will enter or is projected to enter the restricted zone within a number of time units and/or time resources; the UE may enter or will enter or is projected to enter the restricted zone at an expected time or in an expected time resource; the location of the UE; and a planned trajectory of the UE.

Example Embodiment D5b. The method of Example Embodiment D5a, wherein taking the at least one action comprises transmitting, to the UE, a message to initiate a cell change procedure to change the from the first cell to a second cell.

Example Embodiment D5c. The method of Example Embodiment D5b, wherein the first cell is associated with a first carrier frequency and the second cell is associated with a second carrier frequency.

Example Embodiment D5d. The method of Example Embodiment D5b, wherein the first cell is associated with a first frequency band and the second cell is associated with a second frequency band.

Example Embodiment D6a. The method of any one of Example Embodiments D1 to D4c, wherein the information indicates at least one of: the UE is leaving the restricted zone; the UE may leave or will leave or is projected to leave the restricted zone; the UE is not in the restricted zone; the UE may leave or will leave or is projected to leave the restricted zone within a number of time units and/or time resources; the UE may leave or will leave or is projected to leave the restricted zone at an expected time or in an expected time resource; the location of the UE; and a planned trajectory of the UE.

Example Embodiment D6b. The method of any one of Example Embodiments D6a to C6b, wherein taking the at least one action comprises transmitting, to the UE, a message to initiate a cell change procedure to change the from the first cell to a second cell.

Example Embodiment D6c. The method of Example Embodiment D5b, wherein the first cell is associated with a first carrier frequency and the second cell is associated with a second carrier frequency.

Example Embodiment D6d. The method Example Embodiment D5b, wherein the first cell is associated with a first frequency band and the second cell is associated with a second frequency band.

Example Embodiment D7. The method of any one of Example Embodiments D1 to D6d, wherein taking the at least one action comprises at least one of: adjusting at least one beamforming parameter to narrow or widen at least one beam transmitted to the UE; adjusting a power of a beam transmitted to the UE; and adjusting a direction of a beam transmitted to the UE.

Example Embodiment D8. The method of any one of Example Embodiments D1 to D7, wherein taking the at least one action comprises at least one of: transmitting, to the UE, an adjusted transmit power for use by the UE in receiving or transmitting a signal; transmitting, to the UE, a new or modified DRX configuration for use by the UE in receiving or transmitting a signal; transmitting, to the UE, an indication to turn on a sidelink interface; transmitting, to the UE, an indication to turn off a sidelink interface; and transmitting, to the UE, an indication to increase or reduce a transmission rate of the UE on a sidelink interface.

Example Embodiment D9. The method of any one of Example Embodiments D1 to D8, wherein the network node comprises a server, and wherein taking the at least one action comprises transmitting, to the UE, information that indicates a new trajectory or a modified trajectory for the UE.

Example Embodiment D10. The method of any one of Example Embodiments D1 to D9, comprising determining a characteristic associated with the UE, and wherein the at least one action is taken based at least in part on the characteristic associated with the UE.

Example Embodiment D11. The method of Example Embodiment D10, wherein the characteristic comprises at least one of: a type of the UE, a capability of the UE, a type of a user of the UE, and a priority level of the UE.

Example Embodiment D12. The method of any one of Example Embodiments D1 to D11, wherein the network node comprises a gNodeB (gNB).

Example Embodiment D13. The method of any of the previous Example Embodiments, further comprising: obtaining user data; and forwarding the user data to a host or a user equipment.

Example Embodiment D14. A network node comprising processing circuitry configured to perform any of the methods of Example Embodiments D1 to D13.

Example Embodiment D15. A computer program comprising instructions which when executed on a computer perform any of the methods of Example Embodiments D1 to D13.

Example Embodiment D16. A computer program product comprising computer program, the computer program comprising instructions which when executed on a computer perform any of the methods of Example Embodiments D1 to D13.

Example Embodiment D17. A non-transitory computer readable medium storing instructions which when executed by a computer perform any of the methods of Example Embodiments D1 to D13.

### Group E Example Embodiments

Example Embodiment E1. A user equipment (UE) for communicating in a restricted zone, the UE comprising: processing circuitry configured to perform any of the steps of any of the Group A and C Example Embodiments; and power supply circuitry configured to supply power to the processing circuitry.

Example Embodiment E2. A network node for enabling communication of a User Equipment (UE) in a restricted zone, the network node comprising: processing circuitry configured to perform any of the steps of any of the Group B and D Example Embodiments; power supply circuitry configured to supply power to the processing circuitry.

Example Embodiment E3. A user equipment (UE) for communicating in a restricted zone, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Emboidment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for communicating in a restricted zone, the method comprising:
determining location of the UE in relation to the restricted zone; and
based on the location of the UE in relation to the restricted zone, taking at least one action to maintain a level of communication quality of the UE;
wherein determining the location of the UE in relation to the restricted zone comprises determining that the location of the UE is within proximity of the restricted zone; and
wherein taking the action comprises transmitting a message to a network node serving the UE in response to determining that the location of the UE is within proximity of the restricted zone.

2. (canceled)

3. The method of claim 1, wherein determining that the location of the UE is within proximity of the restricted zone comprises at least one of:
determining that a distance between the location of the UE and the restricted zone is less than a threshold amount; and
comparing at least one geographical coordinate associated with the location of the UE to at least one geographical coordinate associated with the restricted zone.

4. The method of claim 1, wherein the step of determining the location of the UE in relation to the restricted zone is performed periodically.

5. The method of claim 1, comprising:
receiving, from a network node associated with a first cell in which the UE is served, a message indicating that the UE is to determine the location of the UE in relation to the restricted zone, and
wherein determining the location of the UE in relation to the restricted zone is performed in response to the message.

6. The method of claim 1, comprising:
determining that a condition has been fulfilled or that an event has occurred, and
wherein the location of the UE in relation to the restricted zone is determined based on the condition being fulfilled or the event having occurred.

7. The method of claim 6, wherein determining that the condition has been fulfilled or that an event has occurred comprises at least one of:
determining that at least one measured signal level has changed by more than a first threshold amount;
determining that at least one measured signal level is more than a second threshold amount;
determining that at least one measured signal level is less than a third threshold amount;
determining that at least one measured signal level differs from a reference value by more than a fourth threshold amount;
determining that the location of the UE has changed by more than a fifth threshold amount; and
determining that the location of the UE has changed by more than a sixth threshold amount within a period of time.

8. The method of claim 1, wherein determining the location of the UE in relation to the restricted zone comprises at least one of:
determining that the UE is entering the restricted zone;
determining that the UE may enter or will enter or is projected to enter the restricted zone within a range of time; and
determining that the UE is in the restricted zone.

9. The method of claim 8, wherein the message comprises at least one of:
information that indicates that the UE is entering or is in the restricted zone;
information that indicates that the UE is about to enter the restricted zone;
information that indicates that the UE may enter or will enter or is projected to enter the restricted zone within a number of time units and/or time resources;
information that indicates that the UE may enter or will enter or is projected to enter the restricted zone at an expected time or in an expected time resource;
information that indicates the location of the UE; and
information indicating a planned trajectory of the UE.

10. The method of claim 1, wherein determining the location of the UE in relation to the restricted zone comprises at least one of:
determining that the UE is leaving the restricted zone;
determining that the UE may leave or will leave or is projected to leave the restricted zone; and
determining that the UE is not in the restricted zone.

11. The method of claim 10, wherein the message comprises at least one of:
information that indicates that the UE is leaving or is not in the restricted zone;
information that indicates that the UE may leave or will leave or is projected to leave the restricted zone within a number of time units and/or time resources;
information that indicates that the UE may leave or will leave or is projected to leave the restricted zone at an expected time or in an expected time resource;
information that indicates the location of the UE; and
information indicating a planned trajectory of the UE.

12. The method of claim 8, wherein the network node is serving the UE in a first cell,
wherein the message is indicative to initiate a cell change procedure; and
initiating, at the UE, a cell change procedure to change from the first cell to a second cell.

13. (canceled)

14. The method of claim 1, comprising receiving, from a network node, information that indicates a new trajectory or a modified trajectory for the UE.

15. The method of claim 1, comprising:
determining a characteristic associated with the UE,
wherein the at least one action is taken based at least in part on the characteristic associated with the UE, and wherein the characteristic comprises at least one of: a type of the UE, a capability of the UE, a type of a user of the UE, and a priority level of the UE.

16. A method by a network node for enabling communication of a User Equipment, UE, in a restricted zone, the method comprising:
receiving, from the UE, a message indicating a location of the UE in relation to the restricted zone or indicating that the location of the UE is within proximity of the restricted zone; and
in response to the received message, taking at least one action to maintain a level of communication quality of the UE.

17. (canceled)

18. The method of claim 16, wherein the information indicates that a distance between the location of the UE and the restricted zone is less than a threshold amount.

19. The method of claim 16, wherein the network node is serving the UE in a first cell, and the method further comprises:
transmitting, to the UE, a message to trigger the UE to determine the location of the UE in relation to the restricted zone.

20. The method of claim 16, comprising configuring the UE to monitor for a fulfillment of a condition or an occurrence of an event, and wherein the location of the UE in relation to the restricted zone is determined based on the condition being fulfilled or the event having occurred.

21. The method of claim 20, wherein the condition is fulfilled or the event has occurred when at least one of:
at least one measured signal level has changed by more than a first threshold amount;
at least one measured signal level is more than a second threshold amount;
at least one measured signal level is less than a third threshold amount;
at least one measured signal level differs from a reference value by more than a fourth threshold amount;
the location of the UE has changed by more than a fifth threshold amount; and
the location of the UE has changed by more than a sixth threshold amount within a period of time.

22-23. (canceled)

24. The method of claim 16, wherein taking the at least one action comprises transmitting, to the UE, a message to initiate a cell change procedure to change the from the first cell to a second cell.

25. (canceled)

26. The method of claim 16, wherein taking the at least one action comprises at least one of:
adjusting at least one beamforming parameter to narrow or widen at least one beam transmitted to the UE;
adjusting a power of a beam transmitted to the UE; and
adjusting a direction of a beam transmitted to the UE.

27. The method of claim 16, wherein taking the at least one action comprises at least one of:
transmitting, to the UE, an adjusted transmit power for use by the UE in receiving or transmitting a signal;
transmitting, to the UE, a new or modified DRX configuration for use by the UE in receiving or transmitting a signal;
transmitting, to the UE, an indication to turn on a sidelink interface;
transmitting, to the UE, an indication to turn off a sidelink interface; and
transmitting, to the UE, an indication to increase or reduce a transmission rate of the UE on a sidelink interface.

28. (canceled)

29. The method of claim 16 comprising:
determining a characteristic associated with the UE,
wherein the at least one action is taken based at least in part on the characteristic associated with the UE, and
wherein the characteristic comprises at least one of: a type of the UE, a capability of the UE, a type of a user of the UE, and a priority level of the UE.

30. A user equipment, UE, for communicating in a restricted zone, the UE comprising processing circuitry configured to:
determine a location of the UE in relation to the restricted zone; and
based on the location of the UE in relation to the restricted zone, take at least one action to maintain a level of communication quality of the UE;
wherein the configuration to determine the location of the UE in relation to the restricted zone comprises a configuration to determine that the location of the UE is within proximity of the restricted zone; and
wherein the configuration to take the action comprises a configuration to transmit a message to a network node serving the UE in response to determining that the location of the UE is within proximity of the restricted zone.

31. (canceled)

32. A network node for enabling communication of a User Equipment, UE, in a restricted zone, the network node comprising processing circuitry configured to:
receive, from the UE, a message indicating a location of the UE in relation to the restricted zone, or indicating that the location of the UE is within proximity of the restricted zone; and
in response to the received message, take at least one action to maintain a level of communication quality of the UE.

33. (canceled)
